(19) United States
(12) Patent Application Publication
(10) Pub. No.: US 2026/0098666 A1
(43) Pub. Date: Apr. 9, 2026

(54) System and method for generating heating and cooling power in a treatment plant for workpieces

(71) Applicant: Dürr Systems AG, Bietigheim-Bissingen (DE)

(72) Inventors: David Carl, Lauffen am Neckar (DE); Dietmar Wieland, Waiblingen (DE); Thomas Klenge, Leonberg (DE); Alexander Hammen, Bönnigheim (DE)

(21) Appl. No.: 19/115,666

(22) PCT Filed: Sep. 27, 2023
(86) PCT No.: PCT/DE2023/100722

§ 371 Date: Mar. 26, 2025

(30) Foreign Application Priority Data
Oct. 4, 2022 (DE) 10 2022 125 538.7
Apr. 27, 2023 (DE) 20 2023 102 300.2

(51) Int. Cl. F25B 25/00; F24D 12/00

(52) U.S. Cl. CPC F25B 25/005; F24D 12/00

(57) ABSTRACT

The present invention relates to a system (100) for generating heating and cooling power in a treatment plant (102) for workpieces, in particular a vehicle body paint shop (103), wherein the system (100) comprises the following:
at least one cold water network (104) for supplying consumer processes (146) with cold water, which has at least one cold water storage device (110) for compensating process load peaks and/or at least one cold water network heat transfer device (112, 154, 158) for recovering heat from consumer processes (146);
at least one warm water network (106) for supplying consumer processes (146) with warm water, which has at least one warm water storage device (120) for compensating process load peaks and/or at least one warm water network heat transfer device (122, 166) for recovering heat from consumer processes (146); and
at least one heat pump device, in particular at least one first heat pump device (132),
   wherein the cold water network (104) is connected to the at least one warm water network (106) by means of the heat pump device (132), and wherein the networks (104, 106) have different temperature levels.

The present invention furthermore relates to a method for generating heating and cooling power in a treatment plant (102) for workpieces, in particular a vehicle body paint shop (103).

### RELATED APPLICATIONS

This application is a national phase of International application No. PCT/DE2023/100722 filed on Sep. 27, 2023, and claims the benefit of German application No. 10 2022 125 538.7 filed on Oct. 4, 2022 and German application No. 20 2023 102 300.2 filed on Apr. 27, 2023, which are incorporated herein by reference in their entirety and for all purposes.

### FIELD OF DISCLOSURE

Examples disclosed herein relate to a system and a method for generating heating and cooling power in a treatment plant for workpieces, in particular a vehicle body paint shop, wherein, in particular, seasonal climatic conditions are taken into account.

### BACKGROUND

In practice, it is known that, in the course of combating global warming, an increasing number of motor vehicle manufacturers are considering electrifying their treatment plants, e.g. their paint shops. If the electric current used for this purpose comes from renewable energy, production can be regarded as CO₂-neutral. In addition to direct electrification processes, e.g. drying processes, other processes are supplied via warm and/or cold water networks.

As is known, the provision of quantities of warm water involves the use of fossil-fuel and/or electric heaters or heating devices. In the case of electric heaters, the electric energy supplied is converted directly into heat energy. In the case of fossil-fuel heaters, the energy supplied is converted with an efficiency of almost 100% into heat for the warm water network, based on the heating value.

However, fossil-fuel heaters do not allow CO₂-neutral operation and are therefore less and less in demand. Where H₂ burners are used as an alternative for heating the warm water network, availability is very dependent on the location and, in addition, there are a number of safety aspects to be considered.

When using electric heaters, the provision of the connected load is the greatest expenditure. Here, the location at which the heaters are set up in the treatment plant plays an important role. In addition, it may be necessary to provide load-center substations to enable the required operating voltage of the heaters to be provided. Depending on the temperature level or temperature, the overall efficiency of a heating system that is operated by purely electric means is furthermore lower by a factor of three to five than a heating system based on heat pumps.

Compression-type refrigerating machines for the provision of quantities of cold water are known. In this case, the electric energy supplied is required for the compression of the refrigerant. The heating power discharged to the surroundings corresponds to the refrigerating power plus the electric power consumed. On average, it is possible here to generate three to four kilowatt-hours of refrigerating energy from one kilowatt-hour of electric energy.

In the case of compression-type refrigerating machines, however, the installed electric powers must be designed for the maximum refrigerating requirement of the connected processes. Thus, in some cases, the peak powers installed are required for only a few hours per year. Moreover, the dissipation of heat to the surroundings is absolutely necessary, and efficiency falls as the external air temperature rises.

In both generation processes, i.e. when generating warm and cold water, the feed temperature of the warm and cold water networks is used as a constant target control variable in order to control the operating power of the heaters or refrigerating machines. In the case of low consumption levels, therefore, the corresponding units, i.e. the heaters or refrigerating machines, are switched off, for example, with the number and size of the units being defined by the maximum power required.

The required refrigerating and heating powers vary greatly within a year or even within a day since they are dependent on the external climatic conditions. Thus, in some cases, the units installed are in operation for a fraction of the year. Moreover, it must always be taken into account that, owing to the fluctuations in the external conditions within one day, heating powers are required at night and cooling powers are required in the daytime.

Owing to the known climatic fluctuations, it is accordingly normal for the heater powers to be designed for winter operation and those of the refrigerating machines to be designed for summer operation, as a result of which none of the units is generally fully utilized at any one time.

In order to recover heat from exhaust air of the treatment processes in the plant, inter alia for reasons of sustainability and efficiency, it is fed into an existing warm water network. This is accomplished by means of heat exchangers and is therefore only possible if the exhaust air flow has a higher temperature level than the warm water network. In other words, the temperature level of the warm water network limits the temperature level of heat recovery. For heat recovery from exhaust air to be even possible, there is therefore a need for higher temperatures of the exhaust air flows than those of the warm water network.

In a treatment plant, such as a vehicle body paint shop, warm water is generally used for air conditioning. The temperature level for this purpose is determined by the air conditioning in winter (dry, cold air). This level must be sufficiently high for the external air to be raised to the specific enthalpy level of the target state. By means of the subsequent spray humidification (adiabatic), the target state with the required relative humidity is then achieved. In this case, it must be taken into account that high temperature differences between the air flows that leave the treatment plant and those which are drawn into the treatment plant arise in winter. This leads to an enthalpy difference between inflowing and outflowing air flows of the plant. This enthalpy difference must be expended for the air conditioning of the plant.

The feed temperature of the warm water, which is used as a constant target control variable, is determined by the heating of the external air in winter. Before the dry external air is humidified, it must be heated up until the air has the enthalpy to evaporate the water to be absorbed and the setpoint temperature to be achieved. The required enthalpy of the dry air is thus set to the corresponding temperature by heating. The temperatures of the dry air required are all the higher, the higher the air humidity is supposed to be. This difference is greatest in the cold winter months.

In summer, on the other hand, the external air already has a relatively high humidity, as a result of which the required temperature level of the warm water circuit is lower since the inflowing air flows do not have to be heated to the same extent.

At a constant temperature level of the warm water network of a treatment plant, the temperature level itself is therefore determined by the driest and coldest external air and is consequently higher than required for a long period of the year.

### SUMMARY

Examples disclosed herein are based on the object of providing a system which supplies consumer processes of a treatment plant for workpieces with heating and cooling powers in a manner that is energy-optimized and sustainable.

According to examples disclosed herein, this object is achieved by means of a system having the features according to claim 1.

The system serves to generate and supply heating and cooling power in a treatment plant for workpieces, in particular a vehicle body paint shop.

The system according to examples disclosed herein preferably comprises the following:
at least one cold water network for supplying consumer processes with cold water, which has at least one cold water storage device for compensating process load peaks and/or at least one cold water network heat transfer device for recovering heat from consumer processes;
at least one warm water network for supplying consumer processes with warm water, which has at least one warm water storage device for compensating process load peaks and/or at least one warm water network heat transfer device for recovering heat from consumer processes; and
at least one heat pump device, in particular at least one first heat pump device,
   wherein the at least one cold water network is connected to the at least one warm water network by means of the at least one heat pump device, and wherein the networks have different temperature levels.

It is advantageous if the system furthermore comprises at least one hot water network for supplying consumer processes with hot water, wherein the at least one hot water network has at least one hot water storage device for compensating process load peaks.

Provision can furthermore be made for the at least one hot water network to have at least one hot water network heat transfer device for recovering heat from consumer processes. The system furthermore preferably comprises at least one second heat pump device, wherein
a) the at least one warm water network is connected to the at least one hot water network by means of the at least one second heat pump device, or
b) the at least one hot water network is connected to the at least one cold water network by means of the at least one second heat pump device.

As a particular preference, the system according to examples disclosed herein comprises the following overall:
at least one cold water network for supplying consumer processes with cold water, which has at least one cold water storage device for compensating process load peaks and/or at least one cold water network heat transfer device for recovering heat from consumer processes;
at least one warm water network for supplying consumer processes with warm water, which has at least one warm water storage device for compensating process load peaks and/or at least one warm water network heat transfer device for recovering heat from consumer processes;
at least one hot water network for supplying consumer processes with hot water, which has at least one hot water storage device for compensating process load peaks and/or at least one hot water network heat transfer device for recovering heat from consumer processes;
at least one first heat pump device; and
at least one second heat pump device,
   wherein the at least one cold water network is connected to the at least one warm water network by means of the at least one first heat pump device, wherein the at least one hot water network is connected to the at least one warm water network or the at least one cold water network by means of the at least one second heat pump device, and wherein the networks have different temperature levels.

Examples disclosed herein are based on the fundamental concept that, in a treatment plant for workpieces, central hot, warm and cold water generation in three corresponding networks is preferably provided by means of two heat pump devices or heat pumps, wherein the networks are connected to one another via the heat pumps. Here, the different seasonal climatic conditions in summer (warm and humid ambient air) and winter (cold and dry ambient air) are to be taken into account, such that in summer the excess heat from the cold water generation is fed to the warm and hot water networks. If there is heat in addition, this is transferred to the exhaust air via heat transfer devices or heat exchangers or is fed into the surroundings of the treatment plant. In winter, in contrast, the cold water network is used as a heat accumulator through the use of heat recovery measures. By means of the heat pump devices, this recovered heat is then converted to usable warm and/or hot water again.

In addition, as mentioned above, owing to the desire for CO₂-neutral generation of the required cooling, warm and heating water in the treatment plant, complete electrification of the units for cold, warm and hot water generation is to be provided, wherein the installed powers of the units should be as low as possible to take account of considerations of sustainability and energy saving. The energy consumption per workpiece or vehicle body should accordingly be reduced to a minimum, for which purpose, inter alia, the heat recovery measures according to examples disclosed herein are integrated into the system.

Fundamentally, the combined system of the three water networks can be subdivided into three functional regions: the first region forms the heat recovery system, the second region is assigned the heat pump devices and storage devices, and the consumers or consumer processes of the treatment plant are located in the third region.

In this description and the appended claims, the term “network” or “water network” should be understood to mean a number of circuits in interaction, through which the water at the respective temperature level or the respective temperature flows.

In this description and the appended claims, the term “circuit” should be understood to mean a combination of lines, which can be formed by pipes, hoses or the like, forms an open or closed circuit, and through which the water at the respective temperature level can flow in one direction, preferably in two directions, wherein the circuit may directly or indirectly comprise further elements, e.g. consumer processes, heat transfer devices, storage devices or heat pump devices.

In this description and the appended claims, the term “consumer process” or “consumer” should be understood to mean any process or any plant apparatus which requires the provision of cold, warm or hot water in the context of treating workpieces.

In this description and the appended claims, the term “connected” should be understood to mean fluidically connected, in particular in a direct or indirect way.

By means of the different temperature levels of the three networks, the very diverse consumer processes or consumers are supplied, wherein a large number of consumer processes or consumers can be connected to the cold and the warm water network. Such processes or consumers are predominantly ventilation devices, which must be regulated for the changing external conditions. Thus, especially in the cold and warm water networks, large fluctuations of the required powers may be observed in the course of a day. In contrast, the processes or consumers of the hot water network, such as one or more pre-treatment stations and one or more intermediate dryers in the case of a vehicle body paint shop, have a very constant heat draw from the network or distribution network, and boilers or burners need only be installed for start-up purposes. In other words, the hot water network is preferably connected to continuous consumer processes.

By virtue of the different temperature levels of the networks, different storage devices can be used. Here, a balance is preferably to be struck between the available space in the treatment plant and the complexity of the storage device.

In respect of the first heat pump device between the cold water network and the warm water network, one or more conventional industrial heat pump devices can be used on account of the low-temperature level of preferably a maximum of 60° C. and the prevailing temperature spread of preferably 30°° C. to 40° C.

The heat recovery by means of the heat transfer devices serves to enable the energy in the consumer process flows leaving the treatment plant to be re-used. With the aid of the heat pump devices, these can be raised to a usable temperature level for the respective network. In this case, the waste heat from the different consumer processes can be fed into the cold water network to make optimum use of it in terms of energy. However, care should be taken to ensure that the first heat pump device has only a certain installed power. This generally depends on the maximum refrigerating power. No later than when this cooling power (including consumer processes in the cold water network) is exceeded, heat recovery measures must be performed in the warm water network. It is particularly process flows in which the dew point is undershot that are significant for heat recovery in terms of energy. Examples of process flows for heat recovery in a vehicle body paint shop are cooling zone exhaust air flows, dryer exhaust air flows, spray booth exhaust air flows, waste heat from compressed air production, exhaust air flows from pre-treatment (VBH) or from cathodic dip coating (KTL), dryer waste heat etc.

It is advantageous if dedicated heat transfer devices for heat recovery are installed for a multiplicity of process flows, with the expenditure on piping having to be set against the benefit.

The case where the heating water network is connected to the cold water network directly via the second heat pump device, i.e. while bypassing the warm water network and the first heat pump device, offers the advantage that the power in the hot water network can be used to generate refrigerating power. In addition, transfer losses are minimized by bypassing the warm water network, thereby increasing efficiency for the generation of the refrigerating power.

By bypassing the first heat pump device between the cold water network and the warm water network, it is thus even possible to increase efficiency. This is particularly advantageous in the case of hot ambient/climatic conditions (due to the climatic zone and/or the time of year), where, as is known, a high degree of refrigerating power is required. Thus, the waste heat required for the generation of cold can be used in the hot water network by the consumers.

It may be advantageous if the at least one cold water storage device and/or the at least one warm water storage device and/or the at least one hot water storage device are/is connected to a feed and a return of the respective network.

By means of the storage devices, which preferably act as buffer stores in the respective network, it is possible to compensate for process load peaks, that is to say both maxima and minima, of the consumer processes attached or connected to the respective network. To ensure that the size of the respective storage device remains economically attractive, the size or capacity is designed for smoothing or leveling the load curve of one day. The resulting advantage is, on the one hand, that the heat pump devices can be made smaller and, on the other hand, that continuous operation of the heat pump devices becomes possible. Moreover, fluctuations in heat recovery in the case of changes in consumer process conditions can be absorbed and transmitted in a metered manner to the consumer processes.

Provision can furthermore be made for each of the networks to comprise at least one consumer process circuit and/or at least one heat pump circuit, wherein the at least one storage device of the respective network is incorporated directly or indirectly into each of the circuits.

In another embodiment of examples disclosed herein, provision can be made for at least one of the networks to comprise at least one heat recovery circuit, into which the respective storage device is directly or indirectly incorporated.

It is advantageous, in particular, if the at least one first heat pump device can be controlled according to at least one variable from the group comprising refrigerating power, heat requirement, temperature, accumulator energy charge and accumulator capacity.

By virtue of the connection to the cold and warm water networks, the first heat pump device generates cold, on the one hand, and heat or heat energy, on the other hand, for the consumer processes. Thus, maximum efficiency and utilization of this heat pump device are achieved. The installed electric power for this heat pump device depends on the maximum refrigerating power to be produced since this is generally greater than the maximum heating power. The maximum heating and refrigerating power of the first heat pump device is reduced by the storage devices of the two networks to the average power requirement on an extreme day.

In summer, the operation of the first heat pump device is preferably determined by the required refrigerating power of the consumer processes. The heating power generated is discharged to the warm water storage device. If the consumption values (including the consumption values of the second heat pump device) are greater than what is generated, any heat recovery taking place is first of all discontinued. If there is still an excess (increase in the feed temperature of the warm water network), the heat generated must first be removed from the warm water network via exhaust air heat transfer devices and, if this is not sufficient, by means of a free cooling device or free cooler.

If the temperature level of the warm water is lowered in summer, the temperature lift of the first heat pump device is reduced. Efficiency is thereby boosted. This leads to lower heat generation in the warm water network. However, the discharge of excess heat energy from the warm water network to the surroundings or to the free cooling device or to the exhaust air is made more difficult. It is then necessary to perform additional hydraulic attachment of the warm water network to the heat exchanger of the exhaust air to be heated since this exhaust air (low-temperature level) feeds its heat energy into the cold water network during winter operation. This expenditure should preferably be set against the benefit.

In winter, the first heat pump device is preferably dimensioned according to the heat requirement of the warm water network. However, since the requirement for cold is not sufficient for generation of the heat energy for the warm water network alone, the cold requirement must be increased. This means that heat must be introduced into the cold water network by means of heat recovery measures, i.e. via the heat transfer device in the process exhaust air. In this way, all the process flows which leave the treatment plant can be reduced almost to the temperature level of the cold water network, thereby making maximum use of the flows leaving the treatment plant in terms of energy.

The installed power of the first heat pump device is preferably designed according to the average daily cold requirement on an extreme day since, according to experience, this represents the larger heat flow for the first heat pump device during operation. Thus, the heat recovery measures for generating the heat energy in winter represent an exploitation of already existing installed power. If the temperature level of the cold water network is lowered, it is possible, on the one hand, to recover more heat by processes and, on the other hand, the temperature lift of the first heat pump device is increased. In this way, more electric energy but less heat energy from the cold water network is required to introduce the same heat energy into the warm water network.

In the transitional periods between summer and winter, the first heat pump device is preferably regulated according to the larger consumers, i.e. ultimately according to the warm or cold water network. Consequently, either the control measures for summer or winter operation are used to ensure that the temperature levels, in particular those of the feed temperatures, of the two networks are held constant. It is here that the first heat pump device operates most effectively since heat and cold generation are to the fore. Ideally, these are in balance in respect of the coefficient of performance (COP) and the energy efficiency ratio (EER) of the heat pump.

It may be advantageous if the at least one further, second, heat pump device is a high-temperature heat pump.

In order to connect the warm or cold water network to the hot water network, a high-temperature heat pump is required, the primary purpose of which is to generate heat energy for the hot water network. In this process, it uses heat energy from the warm or cold water network. Since a high-temperature heat pump of this kind is attached to continuous consumers, the provision of heat must be ensured from the network with the lower temperature level.

In the case where the first and the second heat pump device are linked by the warm water network, heat energy from the cold water network can thus be used indirectly in the hot water network, wherein efficiency must be regarded as higher in comparison with direct generation by means of an electric boiler.

In the case where the cold water network is linked to the hot water network by the second heat pump device, heat energy from the cold water network can be used directly in the hot water network, with losses during transfer into the warm water network and from the latter to the second heat pump device being avoided in comparison with the case presented above.

In another embodiment of examples disclosed herein, provision can be made for the system to have at least one latent heat storage device, which is arranged in the at least one cooling water network and/or in the at least one warm water network.

The addition of a latent heat storage device makes it possible in the system according to examples disclosed herein to store the excess heat energy of the warm water network in summer and to feed this heat energy into the cold water network in winter. Thus, this heat energy from the cold water network is raised to the level of the warm water network with the aid of the first heat pump device.

In another embodiment of examples disclosed herein, provision can be made for the system to have at least one thermal wheel for moisture and heat transfer in the warm water network.

A rotary heat exchanger, also referred to as a thermal wheel, is preferably a heat exchanger which allows moisture and heat recovery in two air flows. Moisture and heat are transferred from one air flow to another by a rotating storage mass alternately being heated up by one air flow and cooled by the other.

Because of the moisture and heat transfer of a thermal wheel, preconditioning of fresh air is possible, and the temperature level of the air ahead of the humidifier inlet can be lowered by virtue of the recovered heat. Thermal wheels are preferably integrated between the inlet and exhaust air of all processes which require humidified inlet air.

It may be advantageous if the at least one warm water network has at least one free cooling device, preferably a free cooling device for summer operation of the treatment plant.

By means of a free cooling device, it is possible, in the event of an excess of heat energy which exceeds heat recovery, i.e. can no longer be transferred by means of a heat transfer device, for the heat generated to be removed from the warm water network.

In another embodiment of examples disclosed herein, provision can be made for the at least one cold water network to have a temperature level of 0° C. to 30° C., preferably 0° C. to 25° C., for the at least one warm water network to have a temperature level of 20° C. to 65° C., preferably 25° C. to 60° C., and for the at least one hot water network to have a temperature level of 55° C. to 100° C., preferably 60° C. to 100° C.

It may be advantageous if the temperature level of the at least one cold water network and/or of the at least one warm water network can be adapted to the air humidity and/or the temperature of an environment of the treatment plant.

Provision can furthermore preferably be made for a storage capacity of the cold water storage device to be greater by 25% to 400%, in particular by 50% to 300%, than a storage capacity of the warm water storage device.

In another embodiment of examples disclosed herein, provision can be made for a storage capacity of the hot water storage device to be smaller than a storage capacity of the cold water storage device and/or of the warm water storage device, preferably 10% to 75% smaller, as a further preference 25% to 50% smaller.

In another embodiment of examples disclosed herein, provision can be made for the at least one hot water network to be connected indirectly and/or directly to the at least one cold water network.

The object of examples disclosed herein can furthermore be achieved by a method for generating heating and cooling power in a treatment plant for workpieces, in particular in a vehicle body paint shop.

The method according to examples disclosed herein is carried out with the system described above and comprises the following steps:
providing cold and/or warm water to the consumer processes of the treatment plant;
temporarily storing heat energy in the cold water storage device and/or the warm water storage device;
recovering heat energy from the exhaust air of one or more consumer processes; and
generating refrigerating power and/or heating power by means of the first heat pump device.

The method can, in particular, have individual or several of the features and/or advantages described in connection with the system.

Furthermore, provision can preferably be made for the method to comprise the following steps in addition:
providing hot water to the consumer processes of the treatment plant; and
temporarily storing heat energy in the hot water storage device.

In another advantageous embodiment of examples disclosed herein, provision can be made for the method to comprise the following step in addition:
generating heating power by means of the second heat pump device.

It may furthermore be advantageous if heat is pumped indirectly and/or directly from the cold water network into the hot water network.

Further features and/or advantages of examples disclosed herein form the subject matter of the following description and the graphical illustration of exemplary embodiments.

### BRIEF DESCRIPTION OF THE DRAWINGS

FIG. 1 shows a schematic illustration of a first embodiment of a system according to examples disclosed herein;

FIG. 2 shows a schematic illustration of a second embodiment of a system according to examples disclosed herein;

FIG. 3 shows a schematic illustration of a third embodiment of a system according to examples disclosed herein;

FIG. 4 shows another schematic illustration of the third embodiment from FIG. 3;

FIG. 5 shows a schematic illustration of a fourth embodiment of a system according to examples disclosed herein;

FIG. 6 shows another schematic illustration of the fourth embodiment from FIG. 5;

FIG. 7 shows a schematic illustration of a fifth embodiment of a system according to examples disclosed herein; and

FIG. 8 shows a schematic illustration of a sixth embodiment of a system according to examples disclosed herein.

Elements which are identical or have the same effect functionally are provided with the same reference signs in all the figures.

### DETAILED DESCRIPTION OF THE DRAWINGS

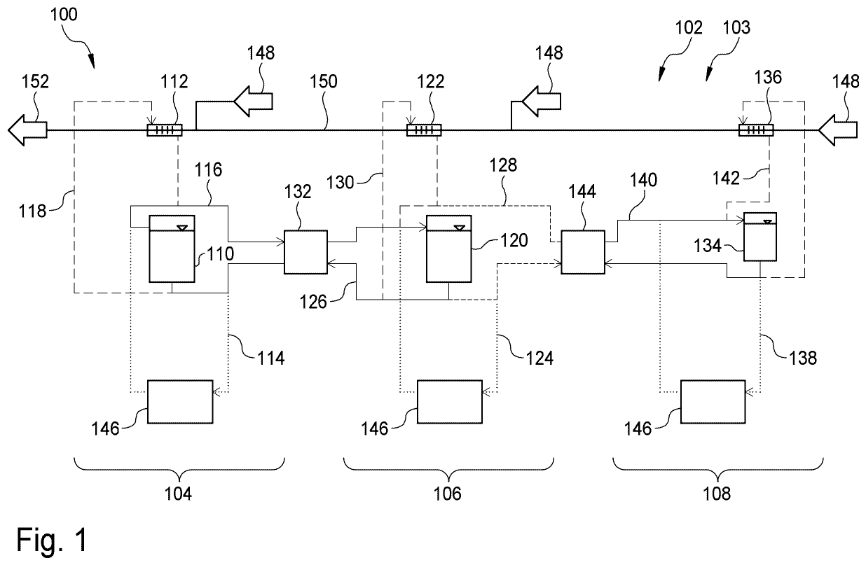

A first embodiment of a system 100 designated 100 as a whole, which is illustrated in FIG. 1, serves to generate heating and cooling power in a treatment plant 102 for workpieces.

The treatment plant 102 is, in particular, a vehicle body paint shop 103.

The system 100 according to examples disclosed herein comprises at least one cold water network 104, at least one warm water network 106 and at least one hot water network 108.

The networks 104, 106, 108 preferably have different temperature levels or different temperatures, that is to say, in particular, the temperature of the water conveyed in the respective network differs from the temperature of the water conveyed in the two other networks.

The cold water network 104 preferably has a temperature level of 0° C. to 25° C., the warm water network 106 preferably has a temperature level of 25° C. to 60° C., and the hot water network 108 preferably has a temperature level of 60° C. to 100° C.

The cold water network 104 has at least one cold water storage device 110 and at least one cold water network heat transfer device 112.

Furthermore, the cold water network 104 comprises at least one consumer process circuit 114, at least one heat pump circuit 116 and at least one heat recovery circuit 118, in which the cold water network heat transfer device 112 is arranged.

The warm water network 106 has at least one warm water storage device 120 and at least one warm water network heat transfer device 122.

Furthermore, the warm water network 106 comprises at least one consumer process circuit 124, at least one first heat pump circuit 126, at least one second heat pump circuit 128, and at least one heat recovery circuit 130, in which the warm water network heat transfer device 122 is arranged.

The cold water network 104 and the warm water network 106 are connected to one another by means of a first heat pump device 132, in particular the heat pump circuit 116 of the cold water network 104 and the first heat pump circuit 126 of the warm water network 106 are connected to the first heat pump device 132.

The first heat pump storage device 132 is preferably a conventional industrial heat pump.

The hot water network 108 has at least one hot water storage device 134 and at least one hot water network heat transfer device 136.

Furthermore, the hot water network 108 also comprises at least one consumer process circuit 138, at least one heat pump circuit 140 and at least one heat recovery circuit 142, in which the hot water network heat transfer device 136 is arranged.

The warm water network 106 and the hot water network 108 are connected to one another by means of a second heat pump device 144, in particular the second heat pump circuit 128 of the warm water network 106 and the heat pump circuit 140 of the hot water network 108 are connected to the second heat pump device 144.

The second heat pump device 144 is preferably a high-temperature heat pump.

The first and the second heat pump device 132, 144 are electrically operated pump devices with a defined installed power, wherein the defined power is preferably matched to the maximum power to be produced for the required cold or heat in the system 100 in time periods of climatic peak values.

The consumer process circuits 114, 124, 138 of the networks 104, 106, 108 provide cold, warm and/or hot water to one or more consumer processes 146.

In a paint shop 103, consumer processes 146, the exhaust air 148 of which is fed substantially to the one or more cold water network heat transfer devices 112, are, for example, cooling zones or pre-treatment stations. In a paint shop 103, consumer processes 146, the exhaust air 148 of which is fed substantially to the one or more warm water network heat transfer devices 122, are, for example, driers.

Exhaust air 148 discharged from the one or more consumer processes 146 is discharged from the treatment plant 102 via an exhaust air line 150 leading to an exhaust air outlet over the roof 152.

The exhaust air line leads through the heat transfer devices 112, 122, 136 of the networks 104, 106, 108, as a result of which the exhaust air or discharged process media 148 flow through these networks and, in the process, transfer some of the heat energy contained in the exhaust air back to the heat recovery circuits 118, 130, 142.

The exhaust air 148 from the consumer processes 146 is cooled with cold water in the cold water network heat transfer device 112 before it reaches the exhaust air outlet over the roof 152, thereby reducing the exhaust air temperature over the roof to a minimum.

The storage devices 110, 120, 134 are connected to the feed and return of the respective network 104, 106, 108 and damp the fluctuations in the respective network 104, 106, 108 during the provision of water for the consumer processes 146, wherein the capacity of the storage devices 110, 120, 134 is preferably designed to smooth the load curve of the consumer processes 146 within a day. Consequently, the heat pump device 132, 144 can inter alia be designed for a minimum.

Particularly in a paint shop 103, all the consumer processes 146 which are dependent on external conditions, i.e. climatic conditions outside the paint shop, are supplied almost exclusively by the cold water network 104 and the warm water network 106, for which reason the storage capacity of the cold water storage device 110 and of the warm water storage device 120 should be dimensioned so as to be greater than the capacity of the hot water storage device 134.

By virtue of the coupling of the cold water network 104 to the warm water network 106 via the first heat pump device 132, the heat energy fed into the cold water network 104 can be raised by means of the first heat pump device 132 to a temperature level that is useful for the consumer processes 146 supplied by the warm water network 106.

By virtue of the connection of the first heat pump device 132 to the cold water network 104 and to the warm water network 106, this device generates cold, on the one hand, and heat, on the other hand, thereby making it possible to achieve a maximum efficiency and utilization. Moreover, simultaneous generation of refrigerating and heating power is possible outside the extreme months in the winter and summer. The installed electric power is preferably matched to the maximum refrigerating power to be provided.

By means of the second heat pump device 144, consumer processes 146 of the hot water network 108 which have a requirement for a higher temperature level, that is to say, in particular, a water temperature level of over 60° C., can be supplied with the necessary heat energy.

If there is or remains sufficient heat energy in the cold water network 104 and/or in the warm water network 106, this can be raised to the temperature level of the hot water network 108 by means of the second heat pump device 144 or by means of the first and the second heat pump device 132, 144.

Thus, advantageously, no additional equipment for generating the heating and cooling power during normal operation of a treatment plant 102 such as a paint shop 103 is necessary apart from the heat pump devices 132, 144. Apart from this, there are, corresponding to the abovementioned temperature levels of the networks 104, 106, 108, consumer processes 146 which require temperatures over 100° C., e.g. drying processes. Furthermore thermal wheels (not illustrated) for reducing the temperature level of the warm water network 106 can be integrated between the inlet and exhaust air of all consumer processes 146 which require humidified inlet air. Because of the moisture transfer of a thermal wheel, preconditioning of supplied fresh air is possible, and the temperature level of the fresh air ahead of the humidifier inlet can be correspondingly lowered. Conditioning of fresh air to a relative humidity of 65% is thus also possible in winter under dry and cold external conditions.

In summer, the temperature level of the warm water network 106 is preferably lowered, boosting the efficiency of the first heat pump device for cold water generation. However if feeding of excess heat energy from the warm water network 106 to the external air outside the treatment plant 102 or to the exhaust air 148 of the consumer processes 146 is envisaged, raising the temperature level of the warm water network should be considered.

In winter, the temperature level of the cold water network 104 is lowered, thereby making it possible to achieve efficient heat recovery. By virtue of the resulting reduction in the COP, the first heat pump device 132 can provide a larger quantity of heat to the warm water network 106 from the same heat energy from the cold water network 104.

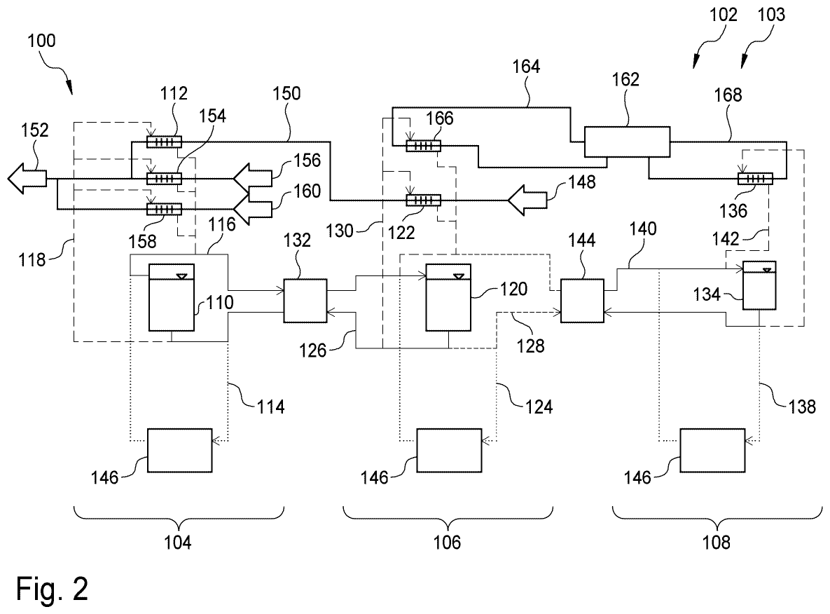

Further details of the differences between the additional embodiments of the system 100 according to examples disclosed herein which are illustrated in FIGS. 2 to 7 will be explored below, wherein it should be understood that all the advantages and technical effects which have been described above in connection with the first embodiment can also be achieved with the embodiments below.

FIG. 2 illustrates a second embodiment of the system 100 according to examples disclosed herein, in which a plurality of parallel heat transfer devices is incorporated into the heat recovery circuit 118 of the cold water network 104. Thus, for example, the heat energy contained in exhaust air 156 coming from a separate consumer process 146 is transferred to the cold water in the heat recovery circuit 118 in a separate heat transfer device 154, and the heat energy contained in exhaust air 160 coming from another separate consumer process 146 is transferred in another separate heat transfer device 158. In addition, the heat energy contained in the exhaust air 148 carried in the exhaust air line 150 is transferred in the heat transfer device 112 to the cold water.

The system 100 furthermore comprises an air compressor device 162, the waste heat from which in a first circuit 164 is transferred to the warm water by means of another heat transfer device 166 in the heat recovery circuit 130 of the warm water network 106, and is transferred in a second circuit 168, by means of a hot water network heat transfer device 136 in the heat recovery circuit 142 of the hot water network 108, to the hot water.

In the second embodiment of the system which is shown in FIG. 2, the exhaust air line 150 preferably does not lead through the hot water network heat transfer device 136.

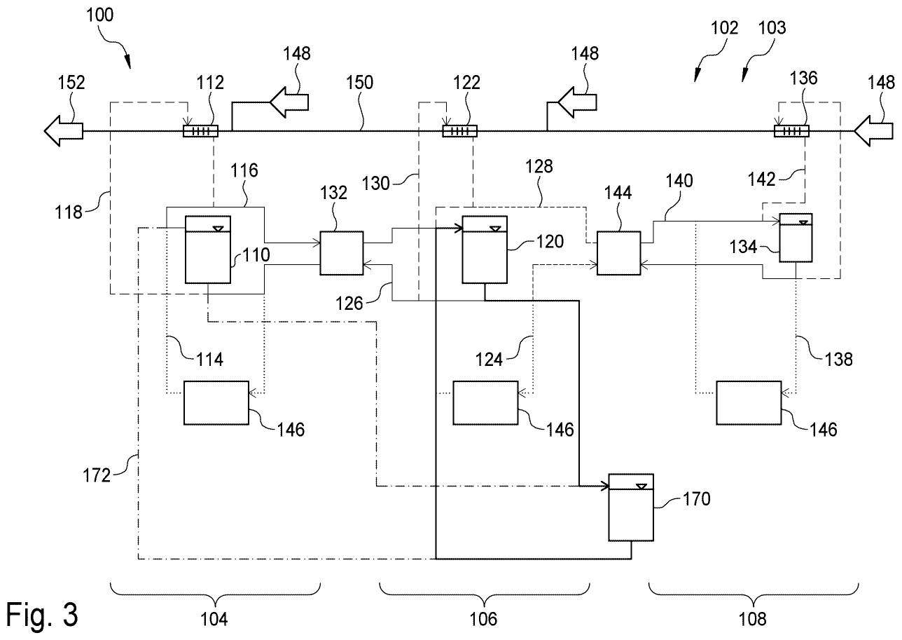

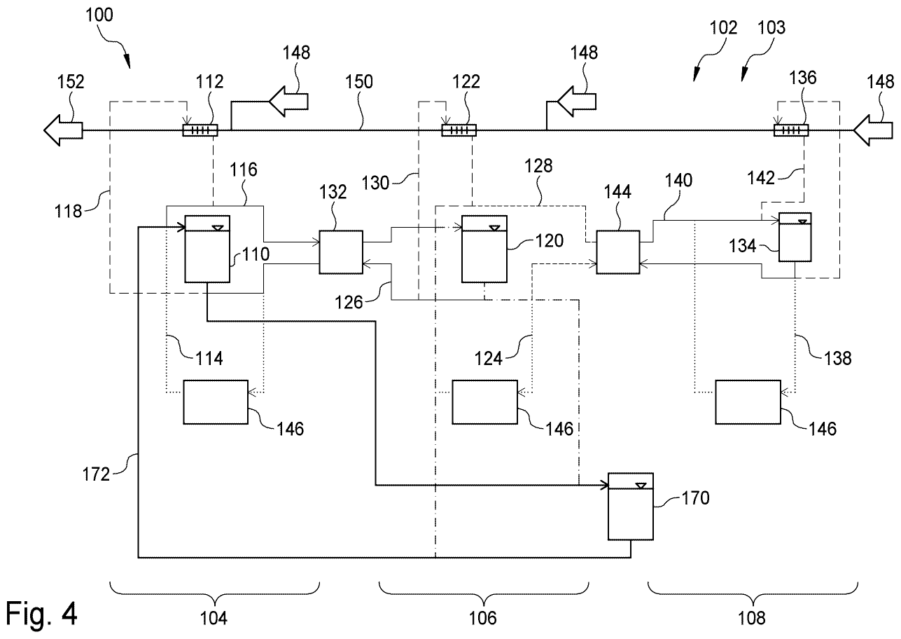

In the third embodiment of the system 100, which is illustrated in FIGS. 3 and 4, a latent heat storage device 170 is provided in addition, said device being connected via a latent heat storage circuit 172 to the cold water network 104 and the warm water network 106. In summer, the excess heat energy of the warm water network 106 is stored in the latent heat storage device 170, as shown in FIG. 3. This heat energy stored in the latent heat storage device 170 can then be made available in the cold water network 104 in winter, as shown in FIG. 4, and can then be raised from the cold water network 104 to the temperature level of the warm water network 106 by means of the first heat pump device 132.

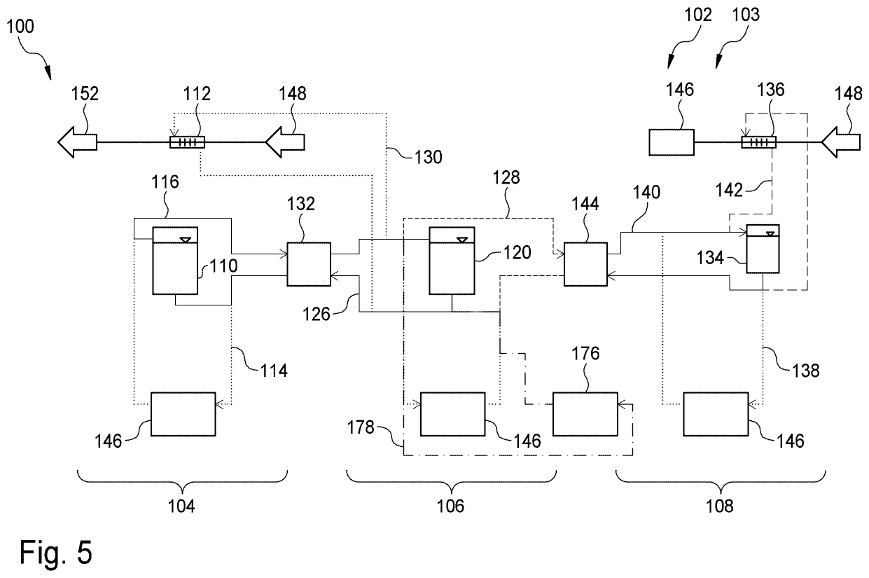

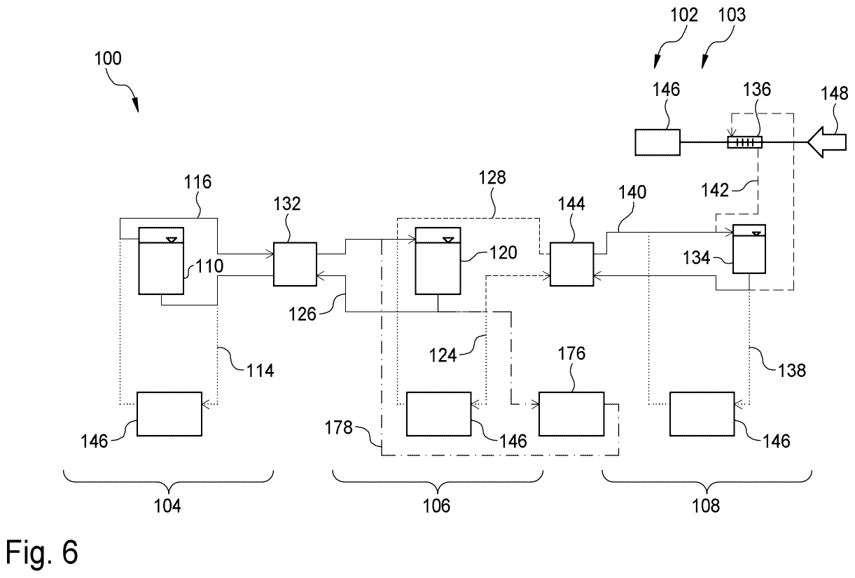

FIGS. 5 and 6 illustrate a fourth embodiment of the system 100 according to examples disclosed herein, wherein the summer mode of the system 100 in the treatment plant 102 can be seen.

In the summer mode, the first heat pump device is determined by the required refrigerating power of the consumer processes 146. The heating power generated is discharged to the warm water storage device 120. If the consumption values, including the second heat pump device 144, are greater than what is generated, any heat recovery taking place via the heat recovery circuit 130 is first of all discontinued, as illustrated in FIG. 6.

If there continues to be an excess, e.g. owing to the increasing of the feed temperature of the warm water network 106, the heat generated must first of all be discharged from the treatment plant 102 over the roof 152 via the exhaust air outlet by means of an exhaust air heat transfer device 174.

If this is not sufficient, a free cooling device 176 should be provided, which is incorporated into the warm water network 106 via a free cooling circuit 178. The excess heat energy can be removed from the warm water network 106 by means of the free cooling device 176.

It can furthermore be seen in the fourth embodiment illustrated in FIGS. 5 and 6 that the cold exhaust air 148 of one or more consumer processes 146 downstream of the hot water network heat transfer device 136 can be fed back to one or even more consumer processes 146, which can use the reduced-temperature exhaust air as inlet air, thereby ensuring that the heat recovery circuit 130 is not additionally subjected to the heat energy from the heat recovery of the hot water network 108.

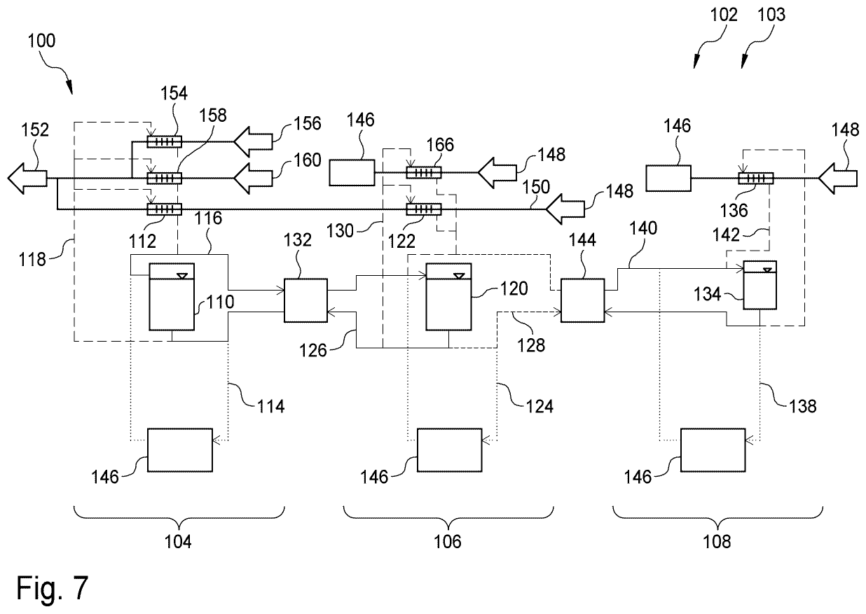

A winter mode is illustrated in FIG. 7 in a fifth embodiment of the system 100. In this fifth embodiment, as in the case of the second embodiment in FIG. 2, the three heat transfer devices 112, 154, 158 are provided in the heat recovery circuit 118 of the cold water network 104, said heat transfer devices recovering heat energy in parallel from the consumer processes 156, 160 and the exhaust air line 150 into the cold water network 104.

In addition, the heat transfer circuit 130 of the warm water network 166 likewise has the further heat transfer device 166, via which—after transfer of the heat energy or at least some of the heat energy from the exhaust air 148 of one or more consumer processes 146—the reduced-temperature exhaust air 148 is fed to one or more consumer processes 146 and thus in the first instance remains in the treatment plant 102.

The same applies to the hot water network 108, in the heat recovery circuit 142 of which the reduced-temperature exhaust air 148 is likewise fed back to one or more consumer processes 146 downstream of the hot water network heat transfer device.

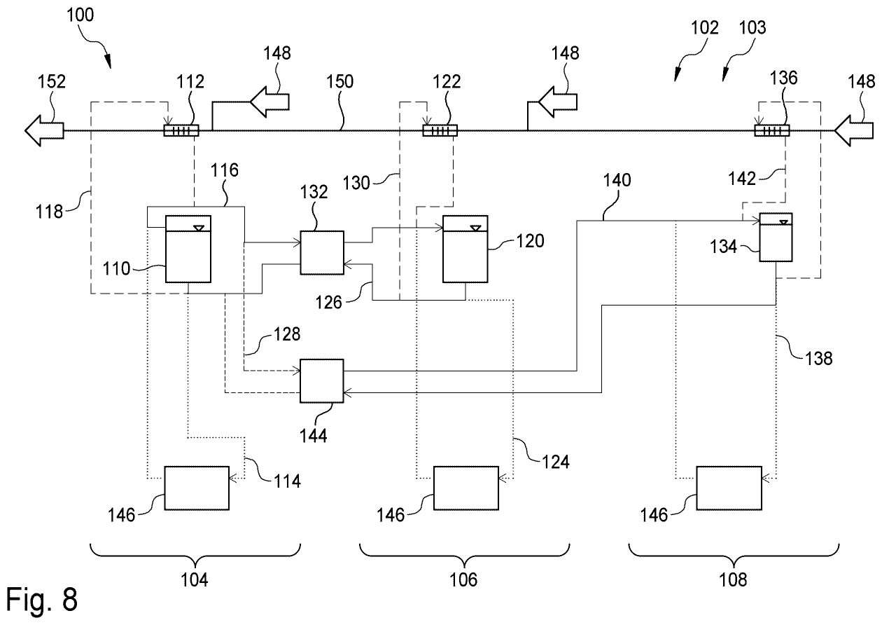

FIG. 8 illustrates, in a sixth embodiment of the system 100, that, in comparison with the first embodiment from FIG. 1, the available power from the hot water network 108 can be used directly as an alternative to the generation of refrigerating power in the cold water network 104. As a consequence, the warm water network 106 and the first heat pump device 132 are bypassed.

For this purpose, on the one hand, the second heat pump device 144 is connected via the second heat pump circuit 128 of the cold water network 104 to the cold water storage device 110 and, on the other hand, via the heat pump circuit 140 of the hot water network 108 to the hot water storage device 134, thereby enabling heat to be pumped directly from the cold water network 104 into the hot water network 108. In this way, the consumer processes in the hot water network 146 can be supplied by means of waste heat from the cold water network 104.

### List of Reference Signs

100 system
102 treatment plant
103 paint shop
104 cold water network
106 warm water network
108 hot water network
110 cold water storage device
112 cold water network heat transfer device
114 consumer process circuit
116 heat pump circuit
118 heat recovery circuit
120 warm water storage device
122 warm water network heat transfer device
124 consumer process circuit
126 first heat pump circuit
128 second heat pump circuit
130 heat recovery circuit
132 first heat pump device
134 hot water storage device
136 hot water network heat transfer device
138 consumer process circuit
140 heat pump circuit
142 heat recovery circuit
144 second heat pump device
146 consumer process
148 exhaust air
150 exhaust air line
152 exhaust air outlet over the roof
154 heat transfer device
156 exhaust air
158 heat transfer device
160 exhaust air
162 air compressor device
164 first circuit
166 heat transfer device
168 second circuit
170 latent heat storage device
172 latent heat storage circuit
174 exhaust air heat transfer device
176 free cooling device
178 free cooling circuit

1. A system for generating heating and cooling power in a treatment plant for workpieces, optionally a vehicle body paint shop, wherein the system comprises:
at least one cold water network for supplying consumer processes with cold water, which has at least one cold water storage device for compensating process load peaks and/or at least one cold water network heat transfer device for recovering heat from consumer processes;
at least one warm water network for supplying consumer processes with warm water, which has at least one warm water storage device for compensating process load peaks and/or at least one warm water network heat transfer device for recovering heat from consumer processes; and
at least one heat pump device, optionally at least one first heat pump device,
wherein the at least one cold water network is connected to the at least one warm water network by the at least one heat pump device, and wherein the networks have different temperature levels.

2. The system as claimed in claim 1, wherein the system includes at least one hot water network for supplying consumer processes with hot water, wherein the at least one hot water network has at least one hot water storage device for compensating process load peaks.

3. The system as claimed in claim 1, wherein the system includes at least one hot water network for supplying consumer processes with hot water, wherein the at least one hot water network has at least one hot water network heat transfer device for recovering heat from consumer processes.

4. The system as claimed in claim 2, wherein the system includes at least one second heat pump device, wherein
a) the at least one warm water network is connected to the at least one hot water network by the at least one second heat pump device, or
b) the at least one hot water network is connected to the at least one cold water network by the at least one second heat pump device.

5. The system as claimed in claim 2, wherein the at least one cold water storage device and/or the at least one warm water storage device and/or the at least one hot water storage device are/is connected to a feed and a return of the respective network.

6. The system as claimed in claim 1, wherein each of the networks includes at least one consumer process circuit and/or at least one heat pump circuit, wherein the at least one storage device of the respective network is incorporated directly or indirectly into each of the circuits.

7. The system as claimed in claim 1, wherein at least one of the networks includes at least one heat recovery circuit into which the respective storage device is directly or indirectly incorporated.

8. The system as claimed in claim 1, wherein the at least one first heat pump device can be controlled according to at least one variable from the group including refrigerating power, heat requirement, temperature, accumulator energy charge and accumulator capacity.

9. The system as claimed in claim 4, wherein the at least one second heat pump device is a high-temperature heat pump.

10. The system as claimed in claim 1, wherein the system has at least one latent heat storage device, which is arranged in the at least one cooling water network and/or in the at least one warm water network.

11. The system as claimed in claim 1, wherein the system has at least one thermal wheel for moisture and heat transfer in the warm water network.

12. The system as claimed in claim 1, wherein the at least one warm water network has at least one free cooling device, preferably a free cooling device for summer operation of the treatment plant.

13. The system as claimed in claim 2, wherein the at least one cold water network has a temperature level of 0° C. to 30° C., preferably 0° C. to 25° C., wherein the at least one warm water network has a temperature level of 20° C. to 65° C., preferably 25°° C. to 60° C., and wherein the at least one hot water network has a temperature level of 55° C. to 100° C., preferably 60° C. to 100° C.

14. The system as claimed in claim 13, wherein the temperature level of the at least one cold water network and/or of the at least one warm water network can be adapted to the air humidity and/or the temperature of an environment of the treatment plant.

15. The system as claimed in claim 1, wherein a storage capacity of the cold water storage device is greater by 25% to 400%, optionally by 50% to 300%, than a storage capacity of the warm water storage device.

16. The system as claimed in claims 2, wherein a storage capacity of the hot water storage device is smaller than a storage capacity of the cold water storage device and/or of the warm water storage device, preferably 10% to 75% smaller, as a further preference 25% to 50% smaller.

17. The system as claimed in claim 2, wherein the at least one hot water network is connected indirectly and/or directly to the at least one cold water network.

18. A method for generating heating and cooling power in a treatment plant for workpieces, preferably in a vehicle body paint shop, wherein the method is carried out with a system as claimed in claim 1 and comprises:
providing cold and/or warm water to the consumer processes of the treatment plant;
temporarily storing heat energy in the cold water storage device and/or the warm water storage device;
recovering heat energy from the exhaust air of one or more consumer processes; and
generating refrigerating power and/or heating power by the heat pump device, optionally the first heat pump device.

19. The method as claimed in claim 18, wherein the method further includes:
providing hot water to the consumer processes of the treatment plant; and
temporarily storing heat energy in the hot water storage device.

20. The method as claimed in claim 18, wherein the method further includes:
generating heating power by a further heat pump device, optionally a second heat pump device.

21. The method as claimed in claim 18, wherein heat is pumped indirectly and/or directly from the cold water network into the hot water network.
